(19) United States
(12) Patent Application Publication
(10) Pub. No.: US 2025/0214223 A1
(43) Pub. Date: Jul. 3, 2025

(54) Adapt-Handle

(71) Applicant: Jonathan Adams, Conway, SC (US)

(72) Inventor: Jonathan Adams, Conway, SC (US)

(21) Appl. No.: 18/402,983

(22) Filed: Jan. 3, 2024

(51) Int. Cl. B25G 3/00

(52) U.S. Cl. CPC B25G 3/00

(57) ABSTRACT

An adaptable handle and mount provided for the use with tools needing the assist of a handle. Handle is used in a horizontal fashion and offers the user a no grip solution. The handle comprises a palm rest that is intended to be positioned in your palm, having additional features for comfort. The handle also includes a hand strap that is fastened to the palm rest, its function is to secure the handle assembly firmly to the hand. Also consists of a connection point for attaching handle to the tool with a threaded bolt, nut, and push-on bolt retainer used for Anti-rotation and handle to tool alignment. Further comprised of a mount consisting of an aluminum block with female threads sized and shaped to allow for sufficient adhesion of a high bond, double sided, acrylic adhesive tape to accommodate original tools design.

### FIELD OF INVENTION

The present invention relates to Adapt-Handle and adaptive mount that gives the user a no grip option, extra comfort, and better control for a tool needing the assistance of a handle.

### BACKGROUND OF THE INVENTION

Currently there isn't a standard handle and strap that can attach to existing tools. That can offer an ergonomic solution while also offering complete and effortless control to the user. Some prior art doesn't offer no grip options. Some gripping options can cause fatigue and/or repetitive strain injuries over time. These problems can be observed with drywall hawk, mud pan, Automotive mixing boards, waiter's trays and more.

### SUMMARY OF THE INVENTION

The present invention seeks to provide a solution to this problem(s) by providing a standard handle that can be adapted to multiple tools without the need for the original tool design to change. Another object is to have a secure hook and loop strap firmly connecting the handle to your hand. Another object offering ergonomic and increased control for the user. Another object in present invention is Adapt-Handle can be used with a variety of existing tools, as well as new tools. Yet another object offering some thermal breakings due to the design's separation with handle and tool.

### BRIEF DESCRIPTION OF DRAWINGS

The description herein refers to the accompanying drawings wherein like reference numerals refer to like parts throughout several views and wherein:

FIG. 1 shows a front view of Adapt-Handle in accordance with the present invention;

FIG. 2 shows a top view of adaptive mount;

FIG. 3 shows a side view and example of using Adapt-Handle and adaptive mount with an existing Mud Pan;

FIG. 4 shows a side view and example using Adapt-Handle without the need of adaptive mount with an existing drywall hawk.

FIG. 5 shows a side view and example of using Adapt-Handle and adaptive mount with an existing automotive mixing board;

FIG. 6 shows a side view and example of using Adapt-Handle and adaptive mount with an existing restaurant serving tray.

### DETAILED DESCRIPTION OF DRAWINGS

Turning now to the drawings in which like reference characters indicate corresponding elements throughout the several views.

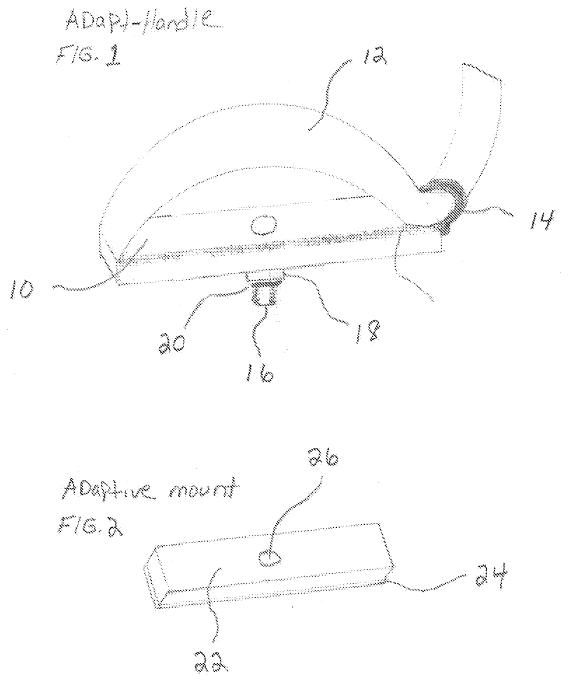

FIG. 1 as indicated to be Adapt-Handle. The palm rests 10 shown with curved edges (radius) on either top, long edges represented by shading, adding increased comfort. Body 12 is a webbing backing hook and loop strap adjustable in nature and for securing the handle firmly to the back of the hand. After positioning the palm rest in the palm of hand. Body 14 is a D ring with a clip used with the hook and loop strap.

Body 16 is a 5/16-18 male thread, used for connecting handle to existing tool mount or use with adaptive mount. Body 18 is a nut used to secure 5/16-18 male thread to palm rests. Body 20 is a 5/16 push-on bolt retainer used for anti-rotation as well as handle tool alignment purposes.

FIG. 2 as indicated to be the Adaptive mount and body 22 is a block of many shapes made of aluminum or other non-rusting materials, to be sufficient size for proper adhesive. For optimal control and improved balance, adaptive mount should be placed as close to the center line of tools as possible. Body 24 is a high bond, double sided foam acrylic adhesive tape. It is attached to the block, with the second side of the adhesive attached to the tool. Body 26 a 5/16-18 female thread and the adapting connection.

FIG. 3 is an example of how Adapt-Handle 28 can be used to connect to tools. Body 30 is a high bond, double sided foam acrylic adhesive tape. 32 is a block made of aluminum or other non-rusting materials, to be sufficient size and shape for adhesive. Body 34 is an existing mud pan, either plastic or metal. For optimal control and improved balance adaptive mount should be placed as close to the center line, both vertical and horizontal, of the tools as possible.

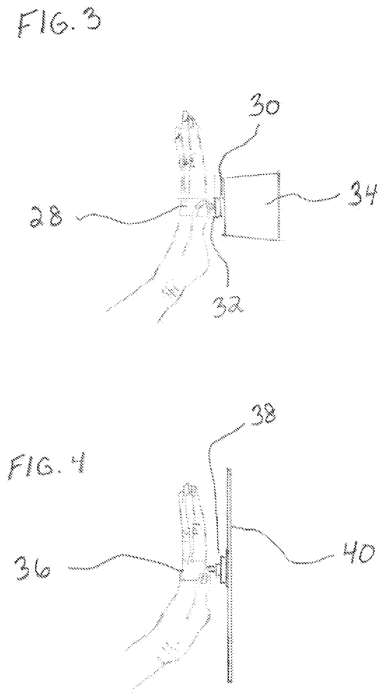

FIG. 4 is an example of how Adapt-Handle 3 can be used to connect to tools. Body 38 is the existing mount already in the hawk design; no adaptive mount needed for this connection. Body 40 is an existing drywall hawk.

FIG. 5 is an example of how Adapt-Handle 42 can be used to connect to tools. Body 44 is a block made of aluminum or other non-rusting materials, to be sufficient size and shape for adhesive. Body 46 is a high bond, double sided foam acrylic adhesive tape. Body 48 is a Bondo pan, either plastic or metal. For optimal control and improved balance adaptive mount should be placed as close to the center line of tools, both vertical and horizontal, as possible.

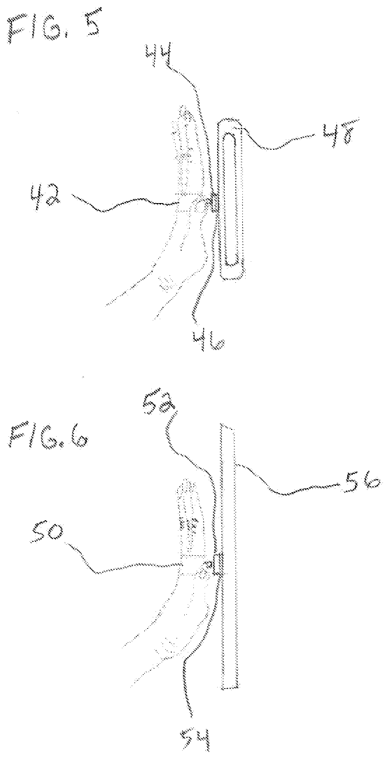

FIG. 6 is an example of how Adapt-Handle 50 can be used to connect to tools. Body 52 is a block made of aluminum or other non-rusting-materials, to be sufficient size and shape for adhesive. Body 54 is a high bond, double sided foam acrylic adhesive tape. Body 56 is an existing serving tray plastic or metal. For optimal control and improved balance adaptive mount should be placed as close to the center line of tools, both vertical and horizontal, as possible.

1. A adapt-handle is a handle allowing connection to multiple tools without the need to grip comprising:
a palm rest being the main component for horizontal use, a hand strap that goes across the back of your hand, a connection point from handle to tool interface, and an adaptive mount used for connection without an existing mount on tools.

2. The adapt-handle of claim 1, wherein adapt-handle is further comprised of a palm rest with contours for comfort to the hand, with strap connection points mounting assembly for connecting to tool, suitable materials plastic, wood or aluminum none rusting materials.

3. The adapt-handle of claim 1, wherein adapt-handle is further comprised of a hand strap and d-ring anchored to the palm rest used for securing the handle to your hand, with a webbing backing and use of hook and loop materials joined with adhesive and/or sewing, fastened to palm rest using rivets, screws, glued or adhesive.

4. The adapt-handle of claim 3, wherein adapt-handle is further comprised of a variation strap material leather and bar buckle fastened to palm rest using rivets, screws, glued or adhesive.

5. The adapt-handle of claim 1, wherein adapt-handle is further comprised of a male threaded connection point and nut from handle to tool including a push-on bolt retainer used for Anti-rotation and handle to tools alignment. making handle easily removable if needed.

6. The adapt-handle of claim 5, wherein adapt-handle is further comprised of a variation quick disconnect allowing for a quick one hand disconnect with a button or lever pressed.

7. The adapt-handle of claim 1, wherein adapt-handle is further comprised of an adaptive mount consisting of an aluminum or no-rusting block with female threads sized and shaped to allow for sufficient adhesion of a high bond, double sided, acrylic adhesive tape and accommodate original tools design.

8. The adapt-handle of claim 7, wherein adapt-handle is further comprised of a variation where handle mount is already integrated into the tool for handle connection without adaptive mount needed. can be welded on for metal tools or even plastic molded for plastic tools.
